(19) United States
(12) Patent Application Publication
(10) Pub. No.: US 2026/0287988 A1
(43) Pub. Date: Sep. 24, 2026

(54) PROJECTION DEVICE AND PROJECTION METHOD FOR PROJECTING IMAGES

(71) Applicant: SAMSUNG ELECTRONICS CO., LTD., Suwon-si (KR)

(72) Inventors: Hyungchul KIM, Suwon-si (KR); Youngjin CHO, Suwon-si (KR)

(73) Assignee: SAMSUNG ELECTRONICS CO., LTD., Suwon-si (KR)

(21) Appl. No.: 19/564,411

(22) Filed: Mar. 12, 2026

Related U.S. Application Data
(63) Continuation of application No. PCT/KR2026/002508, filed on Feb. 11, 2026.

(30) Foreign Application Priority Data
Mar. 19, 2025 (KR) 10-2025-0035276

(51) Int. Cl. G03B 21/14; G03B 21/58; H04N 9/31

(52) U.S. Cl. CPC G03B 21/145; G03B 21/58; H04N 9/3194

(57) ABSTRACT

A projection device includes: a body; a projector in a space inside the body; at least one sensor in the space; a cover configured to open and close the space; a driving motor configured to move the cover to open and close the space; memory storing at least one instruction; and at least one processor, wherein the at least one instruction, when executed by the at least one processor individually or collectively, causes the projection device to: control the driving motor to move the cover to expose the space, control, while the cover is being moved, the projector to project an image having a size corresponding to a degree of exposure of the space, and based on the cover being fully open, control the projector to project a full-size image corresponding to a setting value pre-stored in the memory.

### CROSS-REFERENCE TO RELATED APPLICATIONS

This application is a by-pass continuation of International Application No. PCT/KR2026/002508, filed on Feb. 11, 2026, in the Korean Intellectual Property Receiving Office, and claiming priority to Korean Patent Application No. 10-2025-0035276, filed on Mar. 19, 2025, in the Korean Intellectual Property Office, the disclosures of each of which are incorporated by reference herein in their entireties.

### BACKGROUND

### 1. Field

The present disclosure relates to a projection device and a projection method for projecting images, and more particularly, to a projection device including an operable and closable cover and a projection method for projecting images.

### 2. Description of Related Art

Various electronic apparatuses for providing various functions have been developed with the advancement of electronic technologies. In particular, various types of projection devices have recently been distributed. A projection device refers to a device that projects an image and is capable of implementing a large-sized image compared to other types of display devices by projecting light onto a projection region to display the image.

A projection unit included in the projection device and projecting an image may include at least one lens. When the projection device is not used for a long time, foreign substances such as dust may accumulate on the lens, or the lens may be damaged by an impact from an external object. To prevent these problems, a projection device using a cover capable of covering the projection unit has been introduced.

However, in the case of a related art projection device, a user may feel inconvenience in viewing an image because the projection device may remain in a standby state until the cover is fully opened without projecting the image, or the projection device may project the image in an incomplete state even if the image is projected. In addition, an unnecessary malfunction may occur when a sensor that collects various types of information for projecting an image operates simultaneously during a cover opening process.

### SUMMARY

According to an aspect of the disclosure, a projection device includes: a body; a projector disposed in a space inside the body; at least one sensor disposed in the space; a cover configured to open and close the space in which the projector and the at least one sensor are disposed; a driving motor configured to move the cover to open and close the space; memory storing at least one instruction; and at least one processor, wherein the at least one instruction, when executed by the at least one processor individually or collectively, causes the projection device to: control the driving motor to move the cover to expose the space, control, while the cover is being moved, the projector to project an image having a size corresponding to a degree of exposure of the space, and based on the cover being fully open, control the projector to project a full-size image corresponding to a setting value pre-stored in the memory.

The at least one instruction, when executed by the at least one processor individually or collectively, may further cause the projection device to: deactivate, while the cover is being moved, the at least one sensor and at least one function provided by the projector, and based on the cover being fully open, the at least one sensor and the at least one function.

The at least one sensor may include a passive infrared sensor, and the at least one function may include a brightness adjustment function.

The image having the size corresponding to the degree of exposure of the space may be smaller than the full-size image, and the size corresponding to the degree of exposure of the space may be in proportion to a ratio between a degree of exposure of the space while the cover is fully open and the degree of exposure of the space while the cover is being moved.

The image having the size corresponding to the degree of exposure of the space may have a portion cropped from the full-size image.

The full-size image may be different from the image having the size corresponding to the degree of exposure of the space.

The projection device may further include a communication interface configured to perform communication with a screen, and the at least one instruction, when executed by the at least one processor individually or collectively, may further cause the projection device to: based on the projection device being turned on, control the driving motor to open the cover, transmit, via the communication interface, an opening signal configured to cause the screen to open, and control the projector to project, onto the screen, an image having a size corresponding to the degree of exposure of the space and a degree of opening of the screen.

The at least one sensor may include a distance sensor, and the at least one instruction, when executed by the at least one processor individually or collectively, may further cause the projection device to: identify the degree of opening of the screen based on a sensing value sensed by the distance sensor and the setting value.

According to an aspect of the disclosure, a method of operating a projection device includes: moving a cover of the projection device to expose a space inside a body of the projection device in which a projector and at least one sensor are disposed; while the cover is being moved, projecting, by the projector, an image having a size corresponding to a degree of exposure of the space; and based on the cover being fully open, projecting, by the projector, a full-size image corresponding to a pre-stored setting value.

The method may further include: while the cover is being moved, deactivating the at least one sensor and at least one function provided by the projection device; and based on the cover being fully open, activating the at least one sensor and the at least one function.

The at least one sensor may include a passive infrared sensor and a brightness sensor, and the at least one function may include a brightness adjustment function.

The image having the size corresponding to the degree of exposure of the space may be smaller than the full-size image, and the size corresponding to the degree of exposure of the space may be in proportion to a ratio between a degree of exposure of the space while the cover is fully open and the degree of exposure of the space while the cover is being opened.

The image having the size corresponding to the degree of exposure of the space may have a portion cropped from the full-size image.

The full-size image may be different from the image having the size corresponding to the degree of exposure of the space.

The method may further include: based on the projection device being turned on, transmitting an opening signal to cause a screen to open, wherein the projecting the image having the size corresponding to the degree of exposure of the space may include: identifying a degree of opening of the screen based on a sensing value of the at least one sensor; and causing the projector to project, onto the screen, an image having a size corresponding to the degree of opening of the screen.

According to an aspect of the disclosure, a projection device includes: a projector; at least one sensor; a cover configured to open and close, wherein the projector and the at least one sensor are behind the cover; a driving motor configured to move the cover; memory storing at least one instruction; and at least one processor, wherein the at least one instruction, when executed by the at least one processor individually or collectively, causes the projection device to: cause the driving motor to open the cover; and cause the projector to project an image having a size corresponding to a degree to which the cover is open, and wherein the image corresponds to a setting value while the cover is fully open.

The at least one instruction, when executed by the at least one processor individually or collectively, may further cause the projection device to: while the cover is not fully open, deactivate the at least one sensor and at least one function provided by the projector; and while the cover is fully open, activate the at least one sensor and the at least one function.

The at least one sensor may include a passive infrared sensor, and the at least one function may include a brightness adjustment function.

The image projected by the projector when the cover is fully open may be different from the image projected by the projector when the cover is not fully open.

The projection device may further include a communication interface, and the at least one instruction, when executed by the at least one processor individually or collectively, may further cause the projection device to: based on the projection device being turned on, cause the driving motor to open the cover; transmit, through the communication interface, an opening signal configured to cause a screen to open; and cause the projector to project, onto the screen, an image having a size corresponding to the degree to which the cover is open and a degree to which the screen is open.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a diagram illustrating a projection device according to at least one embodiment of the present disclosure;

FIG. 2 is a block diagram illustrating a configuration of the projection device according to at least one embodiment of the present disclosure;

FIG. 3 is a diagram illustrating an operation of the projection device according to at least one embodiment of the present disclosure;

FIGS. 4, 5, and 6 are diagrams illustrating characteristics of an image projected while a cover is being opened by the projection device according to one or more embodiments of the present disclosure;

FIGS. 7, 8, and 9 are diagrams illustrating various methods in which a projection device according to at least one embodiment of the present disclosure operates in conjunction with an electric screen; and

FIGS. 10 and 11 are flowcharts illustrating projection methods according to one or more embodiments of the present disclosure.

### DETAILED DESCRIPTION

General terms that are currently widely used are selected as terms used in embodiments of the present disclosure in consideration of their functions in the present disclosure, and may be changed based on the intention of those skilled in the art or a judicial precedent, the emergence of a new technique, or the like. In addition, in a specific case, terms arbitrarily chosen by an applicant may exist. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the present disclosure, expressions such as “comprise”, “may comprise”, “have”, “may have”, “include”, or “may include” indicate the presence of a corresponding feature (e.g., a numerical value, a function, an operation, or a component such as a part), and do not exclude the presence of an additional feature.

As used herein, the expressions “at least one of a, b or c” and “at least one of a, b and c” indicate “only a,” “only b,” “only c,” “both a and b,” “both a and c,” “both b and c,” and “all of a, b, and c.”

Expressions such as “first” and “second,” used in the present disclosure may indicate various components regardless of the sequence or importance of the components. The expression is used only to distinguish one component from another component, and does not limit the corresponding component.

A term of a singular number may include its plural number unless explicitly indicated otherwise in the context. It should be understood that in this application, terms such as “comprise”, “include”, or “have” indicate that the presence of the features, numbers, steps, operations, components, parts, or combinations thereof, which are described in the specification, and do not preclude the presence or addition of one or more other features, numbers, steps, operations, components, parts, or combinations thereof.

In the present disclosure, a term such as a “user” may refer to a person who uses a projection device, or an apparatus (e.g., an artificial intelligence electronic apparatus) which uses the projection device.

It will be understood that when an element is referred to as being “connected” with or to another element, it can be directly or indirectly connected to the other element, wherein the indirect connection may include “connection via a wireless communication network”.

Throughout the description, when a member is “on” another member, this includes not only a configuration where the member is in contact with the other member, but also a configuration where there is another member between the two members.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

Hereinafter, various embodiments of the present disclosure are described in more detail with reference to the accompanying drawings.

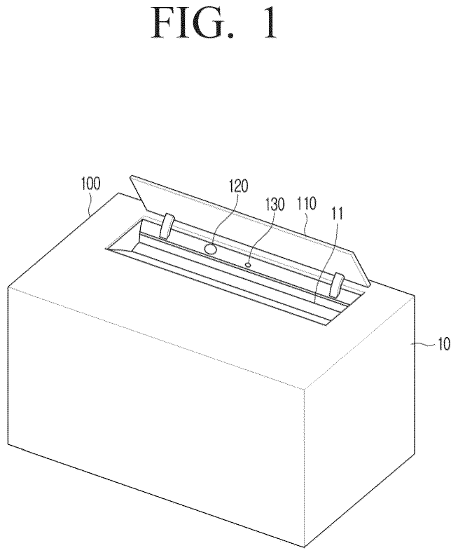

FIG. 1 is a diagram illustrating a projection device 100 according to at least one embodiment of the present disclosure. The projection device 100 may be a device that projects an image onto a projection region. The projection device 100 may be implemented in various ways. Specifically, the projection device 100 may be implemented as a general type designed to be placed on a floor, an aerial type designed to be suspended from a ceiling, a movable type capable of being moved by a traveling means such as a wheel, a short-distance type that projects an image at a position close to the projection region, or the like.

Among these types, the short-distance type may be implemented as an ultra-short-throw projector that projects an image from a floor region close to the projection region (e.g., a screen) toward an upper screen. The ultra-short-throw projector may project a large-sized image even when a distance from the projection region is 0.5 m or less. However, the present disclosure is not limited thereto, and the projection device 100 may be implemented in various other types such as a robot type or a drone type, and may also be implemented in a form in which a projection function is added to a robot cleaner or another electronic apparatus.

The projection device 100 may include a projector 120 for projecting an image and at least one sensor 130 for sensing various types of information related to a projection environment (e.g., brightness or a distance from a projection surface). At least some of the sensors may be disposed at positions close to the projector 120. When dust or another foreign substance adheres to a lens included in the projector 120, a problem such as blurring or obscuring of the image may occur. In addition, when dust or another foreign substance adheres to the sensor 130, it may be difficult for the sensor 130 to sense accurate information. In addition, when the lens of the projector 120 or the sensor 130 is directly exposed to an outer surface of the projection device 100, damage may occur due to an impact from an external object. In consideration of these problems, the projection device 100 may include a cover 110 for covering the projector and the sensors.

When the projector or the sensor is disposed in a specific space formed in a body of the projection device 100, the cover may be implemented to cover the space. The cover 110 may be implemented in a structure that is automatically openable and closable. For example, the cover may be automatically opened when the projection device 100 is turned on or an image projection command is input, and may be automatically closed when image projection ends or the projection device 100 is turned off.

FIG. 1 illustrates a state where the cover 110 is disposed at an upper center of the projection device 100 and covers or closes a space formed at the upper center. According to the structure illustrated in FIG. 1, when an event that requires the cover to be opened (e.g., turning on the projection device or inputting the image projection command into the projection device) occurs in the projection device 100, the cover 110 may be opened by lifting another side upward relative to a hinge coupled to one side of the space. However, the form, disposition, and opening and closing mechanism of the cover are not necessarily limited to the structure illustrated in FIG. 1, and may be variously modified depending on the disposition of the projector and the sensor. For example, when the projection device 100 is disposed on a ceiling, the cover 110 may be disposed on a lower surface of the projection device 100 and may be driven to be opened downward.

In addition, the structure and opening form of the cover 110 may be variously modified depending on the disposition of the projector, the sensor or the like, a form of the space where the projector, the sensor or the like is disposed, or the like. In detail, the cover 110 may be implemented to be opened upward from below, downward from above, leftward from right, or rightward from left, or to be opened left and right from a central portion. The cover 110 may be implemented in any form as long as the cover 110 is capable of opening or closing a specific space. Alternatively, the cover 110 may be implemented to be opened by sliding (for example, sliding in one direction, or sliding in opposite directions in an embodiment including a cover having multiple, separable parts).

When the cover 110 starts to be opened, a space 11 where the projector 120 and the plurality of sensors 130 are mounted may start to be exposed. When the cover 110 is automatically opened, a certain amount of time may be required until the cover 110 is completely opened. An actual projection environment may be incorrectly sensed when some sensors 130 covered by the cover 110 start to operate in a state where the cover 110 is not completely opened. For example, when brightness of the projection environment is sensed based on an amount of light entering through a gap in a state where the cover 110 is only slightly opened, the sensed brightness may be identified as brightness lower than an actual brightness of the projection environment.

The projection device 100 may adjust other output characteristics of an image such as brightness and resolution according to the identified brightness. Accordingly, brightness of the projected image may not match the actual brightness of the projection environment. Information sensed by other sensors as well as the brightness sensor may also differ from the actual projection environment for the same reason, thus causing a malfunction of the projection device 100.

For example, an unintended keystone operation or focusing error may occur due to an operation of a time of flight (ToF) sensor, an image sensor, or the like, and an unintended brightness adjustment error may occur due to an operation of a passive infrared (PIR) sensor, a brightness sensor, or the like.

To prevent such an error, when projection is not performed until the cover 110 is completely opened, a waiting time for a user using the projection device 100 may become longer after turning on the device.

The projection device 100 according to one or more embodiments of the present disclosure may deactivate at least one sensor among the plurality of sensors 130 and at least one function among a plurality of functions provided by the projection device 100 as the cover 110 starts to be opened, and may activate at least one sensor and at least one function when the cover 110 is completely opened.

In addition, the projection device 100 according to the one or more embodiments of the present disclosure may project an image having a size corresponding to a degree of exposure of the space while the cover is moved, and may project a normal-sized image (e.g., a full-sized image) when the cover is completely opened.

According to one or more embodiments, it is possible to solve problems such as increased perceived waiting time by the user and a malfunction occurring during a cover opening process. Accordingly, user satisfaction and convenience may be significantly increased.

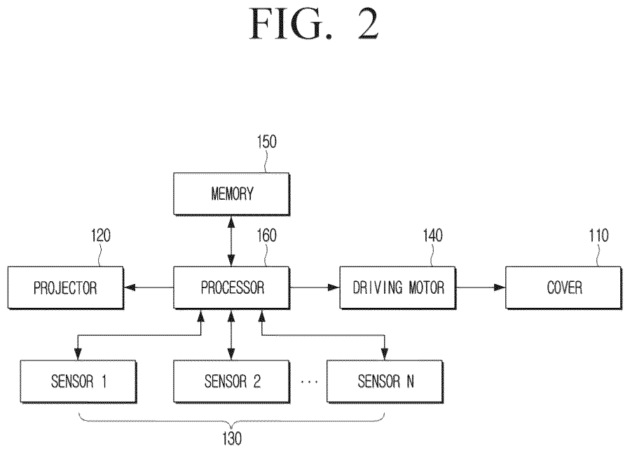

FIG. 2 is a block diagram illustrating a configuration of the projection device 100 according to at least one embodiment of the present disclosure.

Referring to FIG. 2, the projection device 100 may include the cover 110, the projector 120, the plurality of sensors 130, a driving motor 140, a memory 150, and a processor 160. For convenience of illustration, FIG. 2 illustrates one driving motor 140, one memory 150, and one processor 160. However, each of these components is not necessarily required to be implemented as only one, and the number of components may be variously changed depending on the size, characteristic, and design specifications of the projection device 100. Accordingly, even though each component is described in singular form below, it should be interpreted that the component may be implemented as at least one.

The plurality of sensors 130 are components for sensing various types of information required for operating the projection device 100. Among the plurality of sensors 130, some sensors (e.g., a gyro sensor, an acceleration sensor, and a thermal sensor) may be disposed in an internal space of the projection device 100, and some sensors (e.g., the brightness sensor, the image sensor, the time of flight (ToF) sensor, and a laser distance sensor) for sensing characteristics of a projected image or the projection environment (e.g., the brightness or the distance to a screen) may be disposed at positions close to the projector 120. In the case of a projection device having an external shape as illustrated in FIG. 1, the projector 120 and at least one sensor may be disposed in a space formed on an upper surface of the body of the projection device 100.

The cover 110 is a component for opening or closing the specific space where the projector 120 and at least one sensor are disposed. For example, the cover 110 may be implemented to be opened upward from below, downward from above, leftward from right, or rightward from left, to be opened left and right from the central portion.

Hereinafter, the description describes a case where the cover 110 is formed on an upper surface of a body 10 in a form as illustrated in FIG. 1.

The cover 110 may be movable while being connected to the driving motor 140. The cover 110 may be physically and directly coupled to the driving motor 140, and an opening or closing process of the cover may thus be performed based on movement of the motor. In addition, the cover 110 may be indirectly coupled to the driving motor 140 through an intermediate device or connection component. In this case, the intermediate device or connection component may include a belt, a chain, or a gear.

For example, one side of the cover 110 may be coupled to an edge portion of a lower space through the hinge. An actuator that moves according to driving of the driving motor 140 and rotates the cover 110 may be disposed on the hinge. By the actuator, the cover 110 may be opened upward while rotating relative to the hinge. In the present disclosure, a state where the cover 110 rotates up to the maximum angle and exposes the lower space is defined as a fully opened state, and a state from when the cover 110 starts to be opened until before the cover 110 is fully opened is defined as a partially opened state.

The driving motor 140 may be directly or indirectly connected to the cover 110 to enable movement of the cover. The driving motor 140 may be implemented as a direct current (DC) motor, an alternating current (AC) motor, a stepper motor, or a servo motor. The projector 120 is a component for projecting an image. The projector 120 may be implemented by various projection methods (e.g., a cathode-ray tube (CRT) method, a liquid crystal display (LCD) method, a light-emitting diode (LED) method, a digital light processing (DLP) method, or a laser method).

For example, when implemented by the LED method or the LCD method, the projector 120 may include an LED or LCD light source, a liquid crystal (LCD), other lenses, or the like.

The DLP type may display the image by using a digital micromirror device (DMD) chip. The DLP-type projector 120 may include a light source, a color wheel, the DMD chip, a projection lens, or the like. Light output from the light source may be colored as light passes through a rotating color wheel. Light passed through the color wheel may be input to the DMD chip. The DMD chip may reflect light input into the DMD chip. The projection lens may serve to magnify light reflected from the DMD chip into an image size. The light source used in the projector 120 may be implemented in various forms such as a lamp, an LED, or a laser.

The projector 120 may output an image in an aspect ratio of 4:3, an aspect ratio of 5:4, or a wide aspect ratio of 16:9, according to a use of the projection device 100, a user setting, or the like, and may output images at various resolutions such as wide video graphics array (WVGA, 854×480 pixels), super video graphics array (SVGA, 800×600 pixels), extended graphics array (XGA, 1024×768 pixels), wide extended graphics array (WXGA, 1280×720 pixels), WXGA(1280×800 pixels), super extended graphics array (SXGA, 1280×1024 pixels), ultra extended graphics array (UXGA, 1600×1200 pixels), full high-definition (full HD, 1920×1080 pixels), and ultra high-definition (UHD, 3840×2160 pixels), based on the aspect ratio. For the avoidance of doubt, the disclosure is not limited to the foregoing aspect ratios or resolutions.

The projector 120 may be disposed in the internal space 11 of the body 10 together with the plurality of sensors 130, and may be exposed to an external space according to opening of the cover 110. The projection operation of the projector 120 may be controlled by the processor 160.

The processor 160 may determine various output characteristics such as the resolution, size, brightness, contrast, and the like of an image based on values predetermined and stored in the memory 150, and then control the projector 120 to project an image having the determined output characteristics.

In this case, the processor 160 may perform functions such as zoom adjustment, keystone correction, quick corner (four-corner) correction, and lens shift based on values sensed by the plurality of sensors 130. By performing these functions, the processor 160 may correct an image and control the projector 120 to project the corrected image.

The processor 160 may control the projector 120 to project an image having a size corresponding to a degree of exposure of the space 11 according to a degree of opening of the cover 110 and to project a full-size image corresponding to a setting value pre-stored in the memory 150 when the cover 110 is fully opened.

The plurality of sensors 130 may include configurations for obtaining information about an image to be projected by the projection device 100. For example, the plurality of sensors 130 may include a brightness sensor, a color sensor, a time of flight (ToF) sensor, an image sensor, a passive infrared (PIR) sensor, an infrared sensor, a gyro sensor, an acceleration sensor, a proximity sensor, a thermal sensor, an ultrasonic sensor, or a laser distance sensor. However, the disclosure is not limited to the foregoing examples, and may include other sensors.

The brightness sensor is a component for sensing a magnitude of ambient brightness. The processor 160 may identify a change in ambient brightness based on sensing data from the brightness sensor, and control the projector 120 to optimize contrast and brightness of an image according to the change.

The image sensor is a component for capturing a projected image. The processor 160 may identify the shape, size, or the like of the projection surface or identify a color of an image projected onto the projection surface based on an image captured by the image sensor. Accordingly, the processor 160 may adjust white balance or correct color attributes such as a color temperature, and may adjust the size, aspect ratio, or the like of the image according to the shape or the size of the projection surface.

The ToF sensor is an imaging camera system that measures a distance to a subject for each point of an image based on time. The ToF sensor may operate together with or separately from the image sensor. The processor 160 may identify distance information between the projector 120 and the projection surface based on data sensed by the ToF sensor.

The PIR sensor is a sensor for sensing movement of an external object by sensing thermal energy therefrom. Based on a sensing value from the PIR sensor, the processor 160 may automatically adjust brightness of a screen, sense user movement, and perform a function such as changing content of an image or emphasizing a specific portion according to a specific action of the user.

The gyro sensor is a component for sensing the tilt, rotational movement, or the like of the projection device 100. The processor 160 may perform automatic keystone correction or quick corner (four-corner) correction based on a sensing value from the gyro sensor.

In addition, the processor 160 may automatically adjust a focal distance based on a sensing value from the laser distance sensor.

The memory 150 is a component for storing various types of data, programs, instructions, and the like required for operating the projection device 100. For example, the memory 150 may store various setting values preset by the user in relation to image projection. The setting value may include various other information such as information about the full-size image projected when the cover 110 is fully opened, resolution information, basic brightness value, and focal distance.

In addition, the memory 150 may store information about an image to be projected from the projector 120 according to the degree of opening of the cover 110 and information about various sensing values identified by the plurality of sensors 130.

The memory 150 may be implemented as a memory embedded in the projection device 100 (e.g., a volatile memory (e.g., a semi-permanent memory such as a random access memory (RAM)), a non-volatile memory (e.g., a permanent memory such as a read-only memory (ROM), a flash memory, a hard drive, or a solid-state drive), or implemented as a memory detachable from the projection device 100 (e.g., a memory card or an external memory).

The processor 160 may control overall operations of the projection device 100. In detail, the processor 160 may be connected to each component of the projection device 100 and perform the overall operations of the projection device 100 according to the one or more embodiments of the present disclosure by individually or collectively executing the instructions stored in the memory 150.

For example, the processor 160 may be connected to the components such as the memory 150, the projector 120, the driving motor 140, and the plurality of sensors 130 to control the operations of the projection device 100.

The processor 160 may include at least one of a central processing unit (CPU), a graphics processing unit (GPU), an accelerated processing unit (APU), a many integrated core (MIC), a neural processing unit (NPU), a hardware accelerator, or a machine learning accelerator.

When a method according to at least one embodiment of the present disclosure includes a plurality of operations, the plurality of operations may be performed by one processor or by a plurality of processors. For example, when a first operation, a second operation, and a third operation are performed using the method according to at least one embodiment, all of the first to third operations may be performed by a first processor, or the first and second operations may be performed by the first processor (e.g., a general-purpose processor) and the third operation may be performed by a second processor (e.g., an artificial intelligence-specific processor).

In the embodiments of the present disclosure, at least one processor 160 may refer to a system-on-chip (SoC) in which at least one processor and other electronic components are integrated, a single-core processor, a multi-core processor, or a core included in the single-core processor or the multi-core processor, and the core may be implemented as a CPU, a GPU, an APU, an MIC, an NPU, a hardware accelerator, a machine learning accelerator, or the like. However, the embodiments of the present disclosure are not limited thereto. For convenience of description, the operation of the projection device 100 is hereinafter described using the term “processor 160.”

When a turn-on command for the projection device 100 is input, a power supply unit (PSU) of the projection device 100 may supply power to various components (e.g., the light source, a fan, the processor, and the memory).

The processor 160 may be booted by power supply, execute internal firmware, may then perform a self-diagnosis process to check whether the various components are normally operated, and may activate a cooling system (e.g., the fan or a heat sink).

The processor 160 may check input devices connected thereto through various interfaces such as a high-definition multimedia interface (HDMI), a video graphics array (VGA), and a universal serial bus (USB), and receive content from the input device when a signal from the input device is sensed.

The processor 160 may store the received content in the memory 150, decode the content to extract video data, and then generate the image to be projected using the video data. To generate the image to be projected, the processor 160 may perform various operations such as resolution conversion, scaling, frame interpolation, color correction, gamma adjustment, and keystone correction.

While preparing to project the image, the processor 160 may open the cover 110. Specifically, the processor 160 may control the driving motor 140 to open the cover 110. A cover opening operation may be automatically performed when the projection device 100 is turned on, or may be performed when the user actually inputs a command for projecting an image after the projection device 100 is turned on and preparation for image projection is completed. For example, when the user intends to open the cover 110 by using various buttons or other input means disposed on the body 10 of the projection device 100, the processor 160 may control the driving motor 140 to automatically open the cover 110.

The processor 160 may control the plurality of sensors 130. First, the processor 160 may control operations of the ToF sensor. The processor 160 may enable the projection device 100 to accurately focus an image on the projection surface or to adjust the projection range and angle of the projection device 100 based on three-dimensional (3D) depth recognition or distance measurement values sensed by the ToF sensor relative to the projection surface. In addition, the processor 160 may enable a position of the projection device 100 to be sensed in real time to project an image onto a required region, and may prevent distortion of the projected image compared to an originally intended image.

In addition, the processor 160 may control operations of the PIR sensor. When the PIR sensor senses a person or a moving projection surface, the processor 160 may control the projection device 100 to automatically turn on or off power based on a sensing value, and may control the projection device 100 to emphasize a specific portion of an image based on a sensing value obtained by sensing a specific action of the user.

In addition, the processor 160 may control operations of the brightness sensor. When the brightness sensor measures brightness of surrounding light, the processor 160 may control the projection device 100 to automatically adjust screen brightness according to the surrounding environment based on a sensing value.

The processor 160 may control the projector 120. The processor 160 may control the projector 120 to adjust brightness of the projected image, emphasize a specific portion of an image, or control whether to project an image based on sensing values from the plurality of sensors 130. In addition, the processor 160 may determine projection of an image having a size corresponding to a size of an exposed space according to the degree of opening of the cover 110 and a type of the image to be projected, and control the projector 120 to project the determined image.

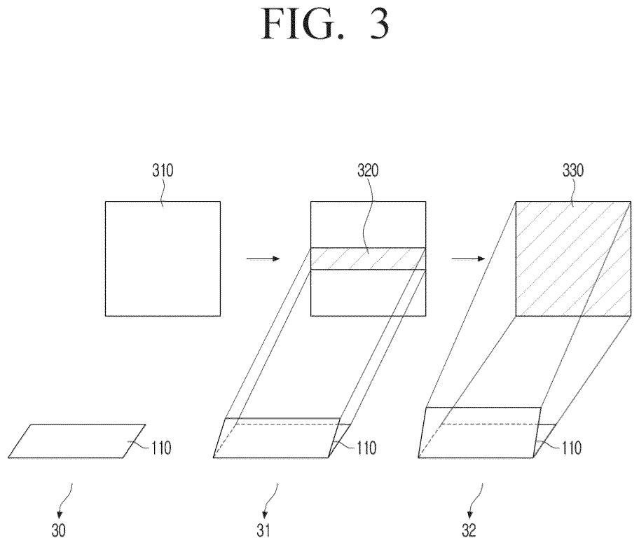

The processor 160 may update the sensing values pre-stored in the memory 150 based on new sensing values obtained from the plurality of sensors 130. Hereinafter, the description describes operations of the projection device 100 in more detail with reference to FIGS. 3 to 9.

FIG. 3 is a diagram illustrating an operation of projecting an image having a size corresponding to a size of a gradually exposed space while the cover is opened by the projection device 100 according to at least one embodiment of the present disclosure.

In a state 30 where the cover is closed, the processor 160 may control all of the plurality of sensors 130 to be turned off and also control the projector 120 not to project any image. As a result, no image may be projected onto a projection region 310.

When the cover starts to be opened from the state 31, the processor 160 may control the projector 120 to project an image 320 having a size corresponding to a degree of exposure of the space while the cover 110 is moved. In detail, while the cover is opened, the processor 160 may control some of the plurality of sensors 130 (e.g., the PIR sensor and the brightness sensor) to be deactivated, and control a brightness adjustment function or the like of an image by the projection device 100 to be deactivated. That is, the processor 160 may deactivate sensors or functions that may cause a malfunction as the cover is partially opened until the cover is completely opened.

Here, other sensors (e.g., the gyro sensor, the thermal sensor, or a tilt sensor) may be operated so that the projected image is focused and distortion in a size of the projected image is prevented.

The degree of opening of the cover may be identified by various methods.

For example, the processor 160 may identify the degree of opening of the cover based on a sensing value from at least one sensor disposed in the lower space of the cover 110. For example, when the ToF sensor is disposed in the lower space, light emitted from the ToF sensor may be immediately reflected by the cover and quickly incident in a fully closed state of the cover, projected to the outside through a partially opened space, reflected, and re-incident in the partially opened state of the cover, and projected through a fully opened space, reflected, and re-incident in the fully opened state. Accordingly, an amount of light incident in the partially opened state and an amount of light incident in the fully opened state may be different. When information about an amount of light corresponding to each degree of opening is previously measured and stored in the memory 150, the processor 160 may identify the degree of opening of the cover by comparing a value sensed by the ToF sensor with a value stored in the memory 150.

In another example, when a rotary encoder, a Hall sensor, or the like is disposed at a hinge portion of the cover 110, the processor 160 may identify a rotation angle of the cover 110 based on a sensing value from the rotary encoder or the Hall sensor. The cover 110 opened and closed by rotating about the hinge may have the rotation angle equal to the degree of opening.

Even when a sensor other than the ToF sensor is disposed therein, the processor 160 may identify the degree of opening of the cover based on a sensing value obtained in a manner similar to that described above. When the degree of opening of the cover is identified, the processor 160 may control the projector 120 to project an image 320 having a size corresponding to a size of the exposed space.

When the cover is in a fully opened state 32, the processor 160 may activate the deactivated sensors and control the projector 120 to project the full-size image according to the setting value pre-stored in the memory 150.

For example, among the plurality of sensors 130, the PIR sensor and the brightness sensor may be deactivated while the cover 110 is being opened, and may be activated after the cover 110 is fully opened. However, types of such sensors are not limited thereto and may be variously changed according to disposition of a sensor in a space and a type of a function performed by the sensor. That is, even if the PIR sensor is disposed at a position capable of performing normal sensing even in the partially opened state of the cover 110, the sensor may be activated immediately from a time point when the cover 110 starts to be moved for opening. Accordingly, whether a malfunction occurs may be checked during the manufacturing process or testing process of the projection device 100, and then, based on a result of the check, activation or deactivation control of each sensor included in the projection device 100 may be set differently and stored in the memory 150.

When all the sensors and functions are activated when the cover 110 is in the fully opened state, the processor 160 may control the projector 120 to project an image having output characteristics based on the setting value stored in the memory 150. For example, the projector 120 may perform an image brightness adjustment function among the plurality of functions provided by the projection device 100. Here, when a value sensed by the ToF sensor matches the value stored in the memory 150 as the cover 110 is fully opened, the processor 160 may stop opening of the cover 110 and control the projector 120 to project the full-size image 330 corresponding to the setting value pre-stored in the memory 150.

FIG. 3 illustrates that both the image size adjustment operation and the control operation for activation of the sensors and the functions are performed. However, the present disclosure is not necessarily limited thereto, and according to an embodiment, only the image size adjustment according to the degree of opening of the cover or only the adjustment of activation or deactivation of the sensors and functions may be implemented.

An image projected in the fully opened state of the cover and an image projected in the partially opened state of the cover may differ only in size for the same image or may differ in both size and content.

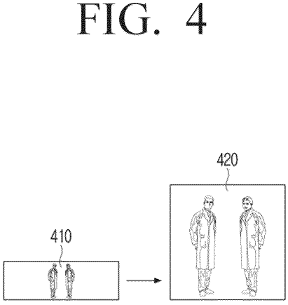

FIGS. 4 to 6 are diagrams illustrating types of images projected while the cover is being opened according to at least one embodiment of the present disclosure.

Referring to FIG. 4, the processor 160 may control the projector 120 to project a small-sized (e.g., downscaled) image 410 in the partially opened state of the cover 110 and to project a large-sized image 420 in the fully opened state of the cover 110.

As illustrated in FIG. 4, the image 410 projected in a partially opened state may be an image having a size reduced from the image 420 projected in the fully opened state in proportion to a ratio of a degree of exposure of the space according to the degree of opening of the cover 110. That is, the processor 160 may control the projector 120 to gradually increase a size of the same image based on the size of exposure of the space according to the degree of opening of the cover 110, and to project the image 420 of a predetermined size, that is, the full-size image 420, in the fully opened state.

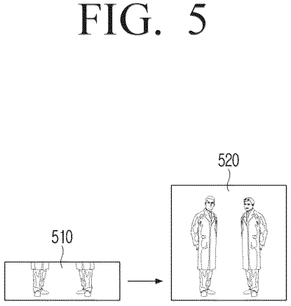

Referring to FIG. 5, the processor 160 may control the projector 120 to project an image 510 having a portion cropped from the full-size image 520 to a size corresponding to a degree of exposure of the space according to the degree of opening of the cover 110. For example, when the cover 110 is opened upward from below and the image 520 is sequentially projected from a lower end thereof, the projector 120 may crop the full-size image 520 into an image having a size corresponding to the size of exposure of the space, and first project the same. As the cover 110 is gradually opened, the processor 160 may also gradually increase a size of the projected image.

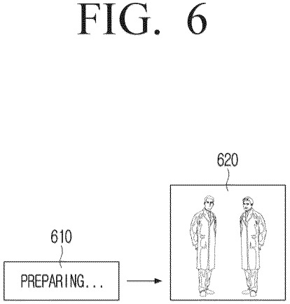

FIG. 6 illustrates a case where different images are projected in the partially opened state and the fully opened state. While the cover is being opened, the processor 160 may control the projector 120 to project an image different from the full-size image 620 projected when the cover is fully opened.

An image 610 displayed in the partially opened state may be referred to as a first image, and the image 620 displayed in the fully opened state may be referred to as a second image. When the second image is an image of movie content, the first image may be an image of various types such as a brand logo of the projection device, a title of content, or text for indicating that projection preparation is in progress.

Alternatively, an additional image related to the second image may be used as the first image. The first image may be pre-stored in the memory 150 or may be provided together with the second image from a content source providing the second image. For example, a name of the projection device, a brand logo thereof, a company name, or text indicating that projection preparation is in progress may be repeatedly used regardless of a type of the second image, and may thus be pre-stored in the memory 150. In contrast, when the first image is an introduction image, a thumbnail image, or the like for the second image, the first image may vary depending on the second image and thus be provided together with the second image from the content source.

Hereinabove, the embodiments describes a case where the projection device 100 is operated regardless of a type of an external projection surface. However, according to other embodiments of the present disclosure, the projection device 100 may also be used together with a screen (also referred to herein as an “electric screen”).

The electric screen may be an electronic apparatus that, in a normal state, waits in a state where the screen, i.e., the projection surface capable of projecting an image, is rolled, bent, or accommodated in a case not to be exposed to the outside, and exposes the screen to the outside when used. For example, when implemented in a rolling state, the screen may be wound around a roller and accommodated in the case, and when the electric screen is driven, the roller may rotate to gradually expose one end of the screen to an outside of the case while being unfolded. An opening through which the screen may pass may be formed in the case. While the roller rotates, at least one support capable of supporting the screen in an unfolded state may expose the screen to the outside by extending from both sides or a rear surface of the screen to the outside of the case while the screen is fixed.

When the projection device 100 is used together with the electric screen, the user is required to wait not only for a time during which the cover 110 is opened and closed but also for a time until a screen is completely opened from the electric screen to view the full-size image. That is, even if the cover is opened earlier or further, it may be difficult for the user to view the full-size image in a state where the screen is less opened.

The projection device 100 according to at least one embodiment of the present disclosure may adjust an image size or adjust activation of the sensor or the function in consideration of each degree of opening of the cover and the screen during their opening.

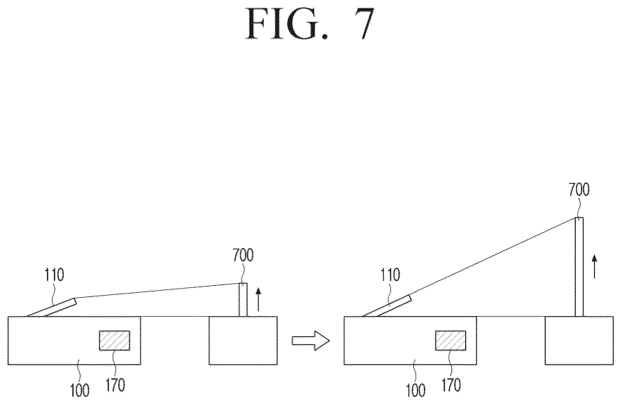

FIG. 7 is a diagram illustrating a case where the projection device 100 according to at least one embodiment of the present disclosure operates together with the electric screen.

Referring to FIG. 7, the projection device 100 may further include a communication interface 170 for performing communication with an external device. The components other than the communication interface 170 are specifically illustrated in FIG. 2 and described with reference thereto, and a redundant illustration of the entire block diagram is thus omitted.

The communication interface 170 is a component for performing communication with various types of external devices by using various types of communication methods. For example, the projection device 100 may perform communication with the electric screen, an external server, or a user terminal device through the communication interface.

The communication interface 170 may include a wireless fidelity (Wi-Fi) module, a Bluetooth module, an infrared communication module, a wireless communication module, or the like. Here, each communication module may be implemented as at least one hardware chip.

The Wi-Fi module and the Bluetooth module may perform communication by a Wi-Fi method and a Bluetooth method, respectively. When the Wi-Fi module or the Bluetooth module is used, various connection information such as a service set identifier (SSID) and a session key may be first transmitted and received to establish a communication connection, and then various types of information may be transmitted and received. The infrared communication module may perform communication by using infrared data association (IrDA) technology for transmitting data over a short distance in a wireless manner by using infrared rays between visible light and millimeter waves.

In addition to the above-described communication methods, the wireless communication module may include at least one communication chip that performs communication according to various wireless communication standards such as Zigbee, third generation (3G), third generation partnership project (3GPP), long term evolution (LTE), LTE advanced (LTE-A), fourth generation (4G), and fifth generation (5G).

Alternatively, the communication interface 170 may include a wired communication interface such as a high definition multimedia interface (HDMI), a DisplayPort (DP), Thunderbolt, a universal serial bus (USB), a red-green-blue (RGB) port, a D-subminiature (D-SUB) port, or a digital visual interface (DVI) port.

In addition, the communication interface 170 may include at least one wired communication module that performs communication by using a local area network (LAN) module, an Ethernet module, or a pair cable, a coaxial cable, or an optical fiber cable.

When the projection device 100 is turned on or the image projection command is input, the processor 160 may open the cover 110 and transmit an opening signal to an electric screen 700 through the communication interface 170 so that the electric screen 700 is opened. The opening signal refers to a signal including a control instruction for instructing the electric screen 700 to open a screen.

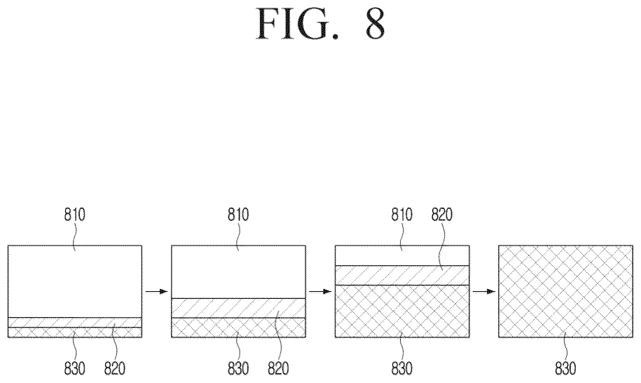

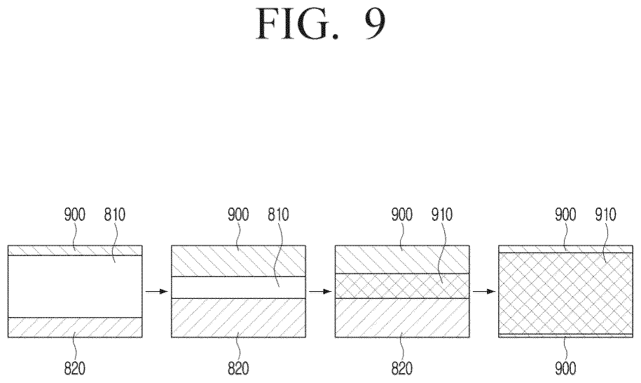

As illustrated in FIG. 7, the processor 160 may control the projector 120 to project, onto a screen 700, the image having a size corresponding to the degree of exposure of the space and a degree of opening of the electric screen 700 according to opening of the cover 110. An image projection process in connection with the electric screen 700 is described in detail below with reference to FIGS. 8 and 9.

The electric screen 700 may be implemented in various forms such as a form of opening a screen upward while being installed on a floor or a form of opening a screen downward while being installed on a ceiling or a wall. Hereinafter, the description specifically describes a difference in a projection region identification method caused by a difference in screen opening directions of the electric screen 700 in a case where the projection device 100 is implemented in a form as illustrated in FIG. 1.

FIG. 8 is a diagram illustrating an image projection process in a case where an opening direction of the cover 110 and an opening direction of the electric screen 700 coincide with each other according to at least one embodiment of the present disclosure. In detail, FIG. 8 illustrates a case where the electric screen 700 is opened while lifting the screen upward.

When the cover 110 is opened in the same direction as illustrated in FIG. 1, a sensing region of the sensor (e.g., the ToF sensor) below the cover 110 may be divided into a region 810 blocked by the cover 110 and an external region 820 recognized through a gap partially exposed as the cover 110 is opened.

The external region 820 may include a region 830 in which a screen of the electric screen 700 is recognized as the electric screen 700 moves upward from below. For convenience of description, the region blocked by the cover 110 is referred to as the first region 810, the external region recognized as the cover 110 is partially opened is referred to as the second region 820, and a region in which the screen is recognized within the external region is referred to as a third region 830. That is, the third region 830 represents a region in which a region sensed by the ToF sensor according to an opening of the electric screen 700 and an area of the screen according to the degree of opening of the electric screen 700 overlap with each other.

When the cover 110 is first opened and then the screen is subsequently opened, the sensing region of the sensor may gradually change as illustrated in FIG. 8.

In detail, in an initial opening stage, the second region 820 and the third region 830 may be recognized as relatively small compared to the first region 810. The processor 160 may control the projector 120 to project an image having a size corresponding to the size of the third region 830 when the size of the third region 830 satisfies the minimum size for image projection. In an embodiment in which the cover is not used together with the electric screen, the processor 160 may control the projector 120 to project an image having a size corresponding to the size of the second region 820.

As illustrated in FIG. 8, while the cover 110 is gradually opened, the size of the third region 830 that is sensed may also be gradually increased. The processor 160 may control the projector 120 to gradually or stepwise increase a size of the image in proportion to the size of the third region 830.

In this case, an aspect ratio of the image may be changed, a size of the image may be adjusted by a pixel interpolation method, or an entire image may be partially cropped and used. Alternatively, as illustrated in FIG. 6, an image different from a final image to be projected may be displayed. When a size of the third region gradually increases as illustrated in FIG. 8, a plurality of preparatory images may be sequentially changed and displayed according to a degree of partial opening and a degree of opening of the screen. For example, numbers such as “3,” “2,” and “1” may be sequentially displayed or text may be changed and displayed as if counting a time required to complete the full opening.

When the cover 110 is in the fully opened state, a value sensed by the ToF sensor may match a value stored in the memory 150. That is, when a distance between the screen and the projection device 100 in a case where the screen of the electric screen 700 is fully opened is previously measured and stored in the memory 150, the processor 160 may determine whether a distance identified based on a sensing value from the ToF sensor matches the distance to the screen to determine whether the screen is fully opened. A size of the screen while the screen is fully opened may also be previously measured and stored. When a size of an opened screen region matches the stored screen size, the processor 160 may identify that the cover and the screen are fully opened.

An image sensor in addition to the ToF sensor may be used. In detail, the processor 160 may analyze each pixel value of an image captured by the image sensor and extract an edge of an object displayed in the image. The processor 160 may distinguish a portion 810 of the image that corresponds to an inner surface of the cover and a remaining portion 820 based on the extracted edge, and identify an object region 830 within the remaining portion 820 that corresponds to the screen.

When the cover and the screen are identified as being in the fully opened state, the processor 160 may control the driving motor 140 and the communication interface 170 to stop opening of the cover 110 and the electric screen 700, and the projection device 100 may control the projector 120 to project an image having a full size corresponding to the setting value stored in the memory 150 onto the region 830 in which the region 820 sensed by the ToF sensor and an area of the screen according to the degree of opening of the electric screen 700 overlap with each other.

In a case as illustrated in FIG. 8 in which the opening direction of the cover and the opening direction of the screen coincide with each other, the region 830 in which the region 820 sensed by the ToF sensor and an area of the screen according to the degree of opening of the electric screen 700 overlap with each other may occur immediately according to opening of the cover and the screen. Accordingly, an image may start to be projected from a lower end of the screen as illustrated in FIG. 8, and as the cover 110 is opened, the projected image may start to gradually increase in size from the lower end to a size of the full-size image.

FIG. 9 is a diagram illustrating a projection process of an image in a case where the opening direction of the cover 110 and the opening direction of the electric screen are opposite to each other according to at least one embodiment of the present disclosure. In detail, FIG. 9 illustrates a case where the electric screen 700 is opened while the screen is lowered from top to bottom.

Referring to FIG. 9, the first region 810 represents a region that has yet to be recognized by the ToF sensor, and the second region 820 represents a region recognized by the ToF sensor as the space 11 where the plurality of sensors 130 and the projector 120 are mounted is exposed while the cover 110 is opened.

As illustrated in a first diagram of FIG. 9, in the initial opening stage of the cover 110, only a portion of the lower region may be recognized. As the external screen is lowered from top to bottom, the actual screen 900 may not be identified because the actual screen 900 is blocked by the first region 810.

When opening of the cover and the screen are respectively progressed in this state, as illustrated in a third diagram of FIG. 9, a screen region 910 may start to be recognized from an upper portion of the second region 820. Sequentially, when the cover 110 is fully opened and the screen is also fully opened, the entire screen region 910 may be recognized.

Similar to the case where the opening direction of the cover and the opening direction of the screen coincide, when the cover 110 is in the partially opened state, the processor 160 may control the projector 120 to project an image having a size corresponding to a region 910 in which a region sensed by the ToF sensor and a projection surface according to the degree of opening of the electric screen 700 overlap with each other.

When the cover 110 is in the fully opened state, the value sensed by the ToF sensor and the value stored in the memory 150 may match each other.

When the processor 160 identifies the fully opened state based on the sensing value and the stored value, the processor 160 may control the driving motor 140 and the communication interface 170 to stop opening of the cover 110 and the electric screen 700, and the projection device 100 may control the projector 120 to project the full-size image corresponding to the setting value pre-stored in the memory 150 onto the region 830 in which the region 820 sensed by the ToF sensor and the region according to the degree of opening of the electric screen 700 match each other.

In the case illustrated in FIG. 9, in which the opening direction of the cover and the opening direction of the screen are opposite to each other, the region 910 in which the region 820 sensed by the ToF sensor and an area of the screen according to the degree of opening of the electric screen 700 overlap with each other may not occur immediately according to opening of the cover and the screen. Therefore, as illustrated in FIG. 9, an image may start to be projected from a central portion of the screen, and as the cover 110 is opened, the projected image may gradually increase in size from the central portion to a size of the full-size image.

Although FIG. 9 illustrates a case of using the ToF sensor, the degrees of opening of the cover and the screen may be identified by various types of sensors such as an image sensor, an infrared sensor, or an ultrasonic sensor in addition to the ToF sensor.

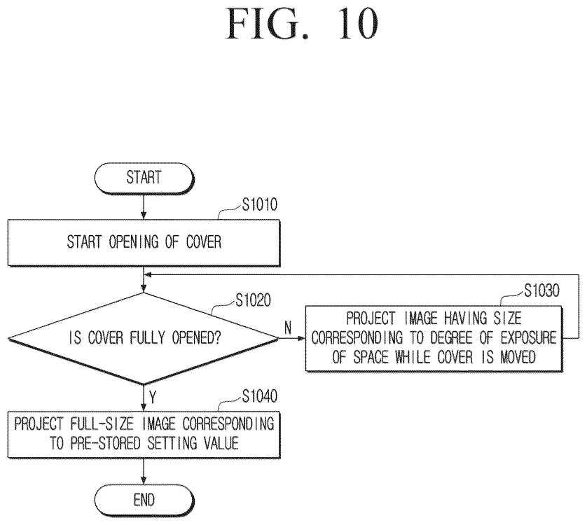

FIG. 10 is a flowchart illustrating a projection method of a projection device according to at least one embodiment of the present disclosure. The projection method illustrated in FIG. 10 may be performed by the projection device including the body having a space where the projector and the plurality of sensors for image projection are mounted in the space and the cover opens and closes the space. The projection device may be implemented to include components as illustrated in FIG. 2. However, the present disclosure is not necessarily limited thereto, and the projection method may be performed by projection device in which some configurations are deleted, changed, or added.

Referring to FIG. 10, in a situation where the projection device is turned on or the image projection command is input, the cover may start to be opened automatically (S1010).

Here, the processor may identify the degree of opening of the cover based on the sensing value from at least one sensor disposed in the lower space of the cover (S1020).

When the sensing values sensed by the plurality of sensors do not match the setting value pre-stored in the memory, the processor may control the driving motor so that the cover is continuously driven until the cover is fully opened, and the cover may correspond to the partially opened state.

When the sensing values sensed by the plurality of sensors become identical to the setting value pre-stored in the memory according to opening of the cover, the processor may control the driving motor to stop the movement of the cover, and the cover may correspond to the fully opened state.

When the cover is in the partially opened state, the image having a size corresponding to a degree of exposure of the space according to the degree of opening of the cover may be projected (S1030).

When the cover is in the fully opened state, the full-size image corresponding to the setting value stored in the memory may be projected (S1040).

The method for initiating opening of the cover, the method in which the projector projects the image having a size corresponding to the space exposed according to opening of the cover when the cover is in the partially opened state, the method for projecting the full-size image corresponding to the setting value pre-stored in the memory when the cover is in the fully opened state, and the like are specifically described in the one or more embodiments described above, and the description provided with reference to FIG. 10 thus omits redundant descriptions thereof.

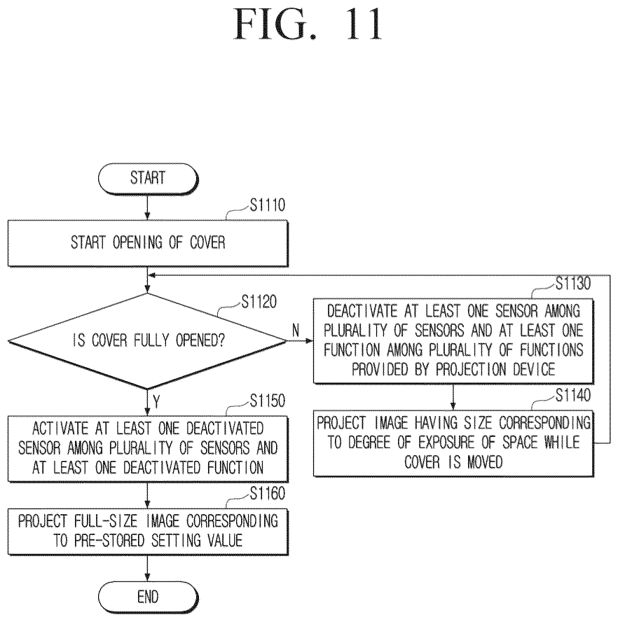

FIG. 11 is a flowchart specifically illustrating a sensor operation in the projection method of a projection device according to at least one embodiment of the present disclosure.

Referring to FIG. 11, in the situation where the projection device is turned on or the image projection command is input, the cover may start to be opened automatically (S1110).

Here, the projection device may identify the degree of opening of the cover based on the sensing value from at least one sensor disposed in the lower space of the cover (S1120).

When the cover is in the partially opened state, the projection device may deactivate at least one function and at least one sensor among the plurality of functions and the plurality of sensors that may cause a malfunction in operations of the functions and sensors in providing the image projection (S1130).

The projection device may project the image corresponding to a size of the space exposed according to opening of the cover by using the projector until the cover is fully opened based on the sensing values sensed by the plurality of sensors and the information stored in the memory (S1140).

When the cover is in the fully opened state, the projection device may activate at least one of functions and sensors deactivated when the cover is in the partially opened state (S1150).

Here, the full-size image corresponding to the stored setting value may be projected based on the sensing values sensed by the plurality of sensors and the information stored in the memory (S1160).

The method for initiating opening of the cover, the method for deactivating at least one function among the plurality of functions and sensors when the cover is in the partially opened state, the method in which the projector projects the image having a size corresponding to the space exposed according to opening of the cover, the method for activating at least one of the functions and sensors deactivated when the cover is in the fully opened state, the method for projecting the full-size image corresponding to the setting value pre-stored in the memory, and the like are specifically described in the various embodiments described above, and the description provided with reference to FIG. 11 thus omits redundant descriptions thereof.

In one or more embodiments, when the cover is in the partially opened state, the projected image may be an image reduced in size in proportion to the full-size image, an image partially cropped from the full-size image, or an image entirely different from the full-size image, and the image projection may also be performed together with opening of the cover and the electric screen when the projection device operates in conjunction with the electric screen.

Further, one or embodiments described above may be implemented by software including instructions stored in a machine-readable storage medium readable by a machine (e.g., a computer).

The machine may be a device capable of operating by invoking instructions stored in a storage medium, and may include an electronic apparatus (e.g., an electronic apparatus A) according to the disclosed embodiments. When the instructions are executed by a processor, the processor may directly perform, or perform functions corresponding to the instructions by using other components under the control of the processor. The instructions may include code generated or executed by a compiler or an interpreter. The machine-readable storage medium may be provided in the form of a non-transitory storage medium. Here, the term “non-transitory” merely indicates that the storage medium is tangible without including a signal, and does not distinguish whether data are semi-permanently or temporarily stored in the storage medium.

In addition, the method according to one or more embodiments described above may be provided as a computer program product. The computer program product may be traded as a product between a seller and a buyer. The computer program product may be distributed in the form of a machine-readable storage medium (e.g., a compact disc read only memory (CD-ROM)) or online through an application store (e.g., Play Store™). In the case of online distribution, at least part of the computer program product may be temporarily stored or generated in a storage medium such as a memory of a manufacturer server, an application store server, or a relay server.

In addition, one or more embodiments described above may be implemented in a computer-readable recording medium or a device similar thereto that uses software, hardware, or a combination thereof. In some cases, the embodiments described in the specification may be implemented in the processor itself. In a software implementation, the embodiments, such as the procedures and functions described in the specification, may be implemented by separate software modules. Each of the software modules may perform at least one function or operation described in the specification.

Computer instructions for performing processing operations of the device according to one or more embodiments described above may be stored in a non-transitory computer-readable medium. When executed by a processor of a specific device, the computer instructions stored in such a non-transitory computer-readable medium may cause the specific device to perform the processing operations of the device according to one or more embodiments described above. The term “non-transitory computer-readable medium” refers to a medium that semi-permanently stores data rather than temporarily storing data, such as a register, a cache, or a memory, and is readable by the device. A specific example of the non-transitory computer-readable medium may include a compact disk (CD), a digital versatile disk (DVD), a hard disk, a Blu-ray disk, a universal serial bus (USB), a memory card, a read-only memory (ROM), or the like.

In addition, each of the components (e.g., modules or programs) according to one or more embodiments described above may include a single entity or a plurality of entities, and some of the corresponding sub-components described above may be omitted or other sub-components may be further included in one or more embodiments. Alternatively or additionally, some of the components (e.g., the modules or the programs) may be integrated into one entity, and may perform functions performed by the respective corresponding components before integration in the same or similar manner. Operations performed by the modules, the programs or other components according to one or more embodiments may be executed in a sequential manner, a parallel manner, an iterative manner or a heuristic manner, at least some of the operations may be performed in a different order or be omitted, or other operations may be added.

Hereinabove, the various embodiments of the present disclosure have been separately described. However, the above-described embodiments are not necessarily implemented individually, and a plurality of embodiments may be partially or entirely coupled and implemented together.

In addition, the present disclosure is not limited to the specific embodiments described above, and various modifications may be made by those skilled in the art without departing from the spirit or scope of the present disclosure as defined by the claims. Such modifications should also be understood to fall within the spirit and scope of the present disclosure.

What is claimed is:

1. A projection device comprising:
a body;
a projector disposed in a space inside the body;
at least one sensor disposed in the space;
a cover configured to open and close the space in which the projector and the at least one sensor are disposed;
a driving motor configured to move the cover to open and close the space;
memory storing at least one instruction; and
at least one processor,
wherein the at least one instruction, when executed by the at least one processor individually or collectively, causes the projection device to:
control the driving motor to move the cover to expose the space,
control, while the cover is being moved, the projector to project an image having a size corresponding to a degree of exposure of the space, and
based on the cover being fully open, control the projector to project a full-size image corresponding to a setting value pre-stored in the memory.

2. The projection device of claim 1, wherein the at least one instruction, when executed by the at least one processor individually or collectively, further causes the projection device to:
deactivate, while the cover is being moved, the at least one sensor and at least one function provided by the projection device, and
activate, based on the cover being fully open, the at least one sensor and the at least one function.

3. The projection device of claim 2, wherein the at least one sensor comprises a passive infrared sensor, and
wherein the at least one function comprises a brightness adjustment function.

4. The projection device of claim 1, wherein the image having the size corresponding to the degree of exposure of the space is smaller than the full-size image, and
wherein the size corresponding to the degree of exposure of the space is in proportion to a ratio between the degree of exposure of the space while the cover is fully open and the degree of exposure of the space while the cover is being moved.

5. The projection device of claim 1, wherein the image having the size corresponding to the degree of exposure of the space has a portion cropped from the full-size image.

6. The projection device of claim 1, wherein the full-size image is different from the image having the size corresponding to the degree of exposure of the space.

7. The projection device of claim 1, further comprising a communication interface configured to perform communication with a screen,
wherein the at least one instruction, when executed by the at least one processor individually or collectively, further causes the projection device to:
based on the projection device being turned on, control the driving motor to open the cover,
transmit, via the communication interface, an opening signal configured to cause the screen to open, and
control the projector to project, onto the screen, an image having a size corresponding to the degree of exposure of the space and a degree of opening of the screen.

8. The projection device of claim 7, wherein the at least one sensor comprises a distance sensor, and
wherein the at least one instruction, when executed by the at least one processor individually or collectively, further causes the projection device to:
identify the degree of opening of the screen based on the setting value and a sensing value sensed by the distance sensor.

9. A method of operating a projection device, the method comprising:
moving a cover of the projection device to expose a space inside a body of the projection device in which a projector and at least one sensor are disposed;
while the cover is being moved, projecting, by the projector, an image having a size corresponding to a degree of exposure of the space; and
based on the cover being fully open, projecting, by the projector, a full-size image corresponding to a pre-stored setting value.

10. The method of claim 9, further comprising:
while the cover is being moved, deactivating the at least one sensor and at least one function provided by the projection device; and
based on the cover being fully open, activating the at least one sensor and the at least one function.

11. The method of claim 10, wherein the at least one sensor comprises a passive infrared sensor and a brightness sensor, and
wherein the at least one function comprises a brightness adjustment function.

12. The method of claim 9, wherein the image having the size corresponding to the degree of exposure of the space is smaller than the full-size image, and
wherein the size corresponding to the degree of exposure of the space is in proportion to a ratio between the degree of exposure of the space while the cover is fully open and the degree of exposure of the space while the cover is being opened.

13. The method of claim 9, wherein the image having the size corresponding to the degree of exposure of the space has a portion cropped from the full-size image.

14. The method of claim 9, wherein the full-size image is different from the image having the size corresponding to the degree of exposure of the space.

15. The method of claim 9, further comprising:
based on the projection device being turned on, transmitting an opening signal to cause a screen to open,
wherein the projecting the image having the size corresponding to the degree of exposure of the space comprises:
identifying a degree of opening of the screen based on a sensing value of the at least one sensor; and
causing the projector to project, onto the screen, an image having a size corresponding to the degree of opening of the screen.

16. A projection device comprising:
a projector;
at least one sensor;
a cover configured to open and close, wherein the projector and the at least one sensor are behind the cover;
a driving motor configured to move the cover;
memory storing at least one instruction; and
at least one processor,
wherein the at least one instruction, when executed by the at least one processor individually or collectively, causes the projection device to:
cause the driving motor to open the cover; and
cause the projector to project an image having a size corresponding to a degree to which the cover is open, and
wherein the image corresponds to a setting value while the cover is fully open.

17. The projection device of claim 16, wherein the at least one instruction, when executed by the at least one processor individually or collectively, further causes the projection device to:
while the cover is not fully open, deactivate the at least one sensor and at least one function provided by the projector; and
while the cover is fully open, activate the at least one sensor and the at least one function.

18. The projection device of claim 17, wherein the at least one sensor comprises a passive infrared sensor, and
wherein the at least one function comprises a brightness adjustment function.

19. The projection device of claim 16, wherein the image projected by the projector when the cover is fully open is different from the image projected by the projector when the cover is not fully open.

20. The projection device of claim 16, further comprising a communication interface,
wherein the at least one instruction, when executed by the at least one processor individually or collectively, further causes the projection device to:
based on the projection device being turned on, cause the driving motor to open the cover;
transmit, through the communication interface, an opening signal configured to cause a screen to open; and
cause the projector to project, onto the screen, an image having a size corresponding to the degree to which the cover is open and a degree to which the screen is open.
